(19) United States
(12) Patent Application Publication
(10) Pub. No.: US 2025/0002424 A1
(43) Pub. Date: Jan. 2, 2025

(54) METHOD AND DEVICE FOR COMPOSTING ORGANIC MATERIAL

(71) Applicants: CIRCULUM VITAE GMBH, Berlin (DE); CIRCULUM VITAE GMBH, Berlin (DE)

(72) Inventors: Aurel LÜBKE, Wels (AT); Pablo METZ, Berlin (DE); Max HUESCH, Berlin (DE); Bernhard GAMERITH, Wels (AT)

(73) Assignees: CIRCULUM VITAE GMBH, Berlin (DE); CIRCULUM VITAE GMBH, Berlin (DE)

(21) Appl. No.: 18/709,452

(22) PCT Filed: Nov. 11, 2022
(86) PCT No.: PCT/EP2022/081642

§ 371 Date: Jun. 17, 2024

(30) Foreign Application Priority Data
Nov. 11, 2021 (DE) 10 2021 212 737.1

(51) Int. Cl. C05F 17/979; C05F 17/60; C05F 17/70; C05F 17/914; C05F 17/986; C05F 17/993

(52) U.S. Cl. CPC C05F 17/979; C05F 17/60; C05F 17/70; C05F 17/914; C05F 17/986; C05F 17/993

(57) ABSTRACT

The proposed solution relates to a method and a device for composting organic material, e.g. a corpse, using a composting container. In this case, it can be provided that at least one of before and during storage of the composting container for a predetermined composting time in each case predetermined amounts of at least one of liquid and oxygen are filled into the composting container, and during the storage at least one rotation of the composting container takes place about an axis of rotation which is non-parallel to an effective direction of a weight force acting on the composting container, and the content of the composting container is held during storage, for a predetermined composting time, in a predetermined temperature range, via at least one heating element.

### CROSS-REFERENCE TO A RELATED APPLICATION

This application is a National Phase patent application of International Patent Application Number PCT/EP2022/081642, filed on Nov. 11, 2022, which claims priority of German Patent Application Number 10 2021 212 737.1, filed on Nov. 11, 2021.

### BACKGROUND

The proposed solution relates to a method and a device for composting organic material.

Organic material is in particular understood to be an (animal) carcass or a (human) corpse. Hitherto, corpses are for example typically cremated during a cremation and buried in an urn. Alternatively, there is the option of burial, in which a corpse is lowered into a grave in the earth. Depending on the ground conditions, in the case of conventional burials the decomposition process can last 20-30 years, in some regions having a high loam content in the ground even up to 50 years.

The possibility of composting as an alternative, ecological burial method is already known. P. Organic AB offers a burial method under the tradename Promessa® in which the corpse, dipped in liquid nitrogen, is processed in a short time to a coarse powder, with the aid of vibrations, and, after additional post-processing steps have been carried out, is buried with a compostable coffin.

The company Recompose from the USA in turn offers a method for composting organic material in which a corpse is laid to rest together with a compostable substrate, in an immovable, honeycombed composting chamber. After a composting time has elapsed, composted material is taken from the cavity and used as plantable humus mixture. However, in this case, in the method proposed by Recompose, the corpse must be laid by hand in the honeycombed composting chamber, together with the substrate by staff. Laying the corpse, in the context of a burial process, is therefore comparatively laborious. Furthermore, in the method implemented by Recompose the composting process appears to be controllable and optimizable only to a limited extent.

### SUMMARY

Against this background, the proposed solution addresses the problem of providing an improved method and an improved device for composting organic material.

In this case, in the course of a proposed method for composting organic material, at least the following steps are provided:
providing a composting container for the organic material to be composted,
introducing the organic material to be composted and a predetermined amount of a composting substrate comprising plant remains into the composting container,
storing the composting container together with the organic material to be composted and the composting substrate for a predetermined composting time, and
post-processing the content of the composting container, resulting from the organic material and the composting substrate (i.e. a first composting mixture), after the predetermined composting time for producing a plantable humus mixture.

In the context of the proposed method, it is now further proposed that
before and/or during the storage of the composting container in each case predetermined amounts of liquid and/or oxygen are filled into the composting container, and/or
during the storage at least one rotation of the composting container takes place about an axis of rotation which is non-parallel to an effective direction of a weight force acting on the composting container.

A basic concept of the proposed solution is therefore that of providing a composting container in which, for the composting process, the organic material and a composting substrate comprising plant remains are stored in a composting container for a predetermined composting time, and, for a composting process (also referred to in the following as main decomposition) taking place in this case, to fill specific amounts of liquid and/or oxygen into the composting container and/or to rotate the entire composting container about an axis of rotation. The composting result, specifically in the case of organic material, can be advantageously influenced by individual and in particular by both of the measures, such that composting of the organic material, to as great an extent as possible, has already occurred after less than 40 days, and thus the content, which can then be removed from the composting container, can then be readily refined, with few mechanical post-processing steps, for producing a plantable humus mixture.

In this case, the introduction of the organic material and of the composting substrate can in principle take place in succession and in particular also in a stepwise manner. This includes, for example, the possibility that initially a partial amount of the composting substrate is introduced into the composting container, subsequently the organic material to be composted, i.e. for example a cadaver or a corpse, is laid on the partial amount of composting substrate already introduced into the composting container, and subsequently a further partial amount of the composting substrate is introduced into the composting container. Alternatively, or in addition, it is also possible for only individual components to be introduced, before or after introduction of the organic material to be composted into the composting container. Thus, for example, initially only a certain type of plant remains, or a mixture of plant remains can be introduced into the composting container, before subsequently the organic material is introduced into the composting container and/or further components of the composting substrate are introduced into the composting container. In principle, a partial amount of composting substrate provided after introduction of the organic material can be used to cover the organic material, already introduced into the composting container, with composting substrate at least in part or completely.

The storage of the composting container for the predetermined composting time can in principle take place while preventing the introduction of additional organic material into the composting container. Consequently, during the predetermined composting time the composting container is closed, and, except in emergencies (for example in the case of a possible malfunction of a device provided for the composting), is not accessible from the outside. As a result, in particular a prescribed peace in death can be observed.

The composting substrate used can for example also comprise biochar and/or rock flour and/or powdered clay, in addition to a predetermined composition of plant remains. In this case, the biochar can in particular serve for odour binding. The further components of the composting substrate are furthermore selected with a view to a sufficiently high absorbency and are comparatively dry.

While an addition of certain amounts of liquid and/or oxygen, provided before and/or during the storage of the composting container, improves the course of the composting process in view of biological parameters, the rotation of the composting container about an axis of rotation non-parallel to the effective direction of the weight force has been found to be advantageous, in view of the course of the composting process, in particular in that sinking of the organic material and/or clumping of the organic material or of parts of the organic material can be effectively prevented thereby. In this case, an axis of rotation that is non-parallel to the effective direction of the weight force can then for example be understood to be an axis of rotation that does not extend vertically, but rather for example at an angle, and thus inclined or obliquely to the vertical, and in particular at an angle of 90° to the vertical, and thus horizontally.

The liquid to be added before and/or during the storage of the composting container can for example contain water. In particular, the liquid can consist largely or exclusively of water.

The amount of liquid to be supplied before the composting process, in each case, can, in terms of weight, many times exceed the weight of the organic material to be composted. For example, the amount of liquid supplied before the composting container is moved can exceed the weight of the organic material by at least 2.5 to 3.5 times. In contrast, the amount of a liquid supplied during the composting process can be less, in terms of weight, than the weight of the organic material originally introduced into the composting container.

For automating the composting process, a variant of the proposed method can provide that at least the amount of liquid and/or oxygen to be filled into the composting container during the storage is filled into the composting container at at least one timepoint that can be predetermined by means of an electronic controller. This in particular includes a variant in which the amount of liquid and/or oxygen to be filled into the composting container during the storage is filled in via at least one inflow connection of the composting container, in particular automatically (i.e. without the need of user intervention for the filling), or in a user-controlled manner. In particular, at least one first inflow connection can be provided for the liquid, and at least one second inflow connection can be provided for the oxygen.

Alternatively, or in addition, the amount of liquid and/or oxygen to be filled in and/or the amount of composting substrate to be introduced can be predetermined automatically by control electronics depending on a detected weight and/or a detected size of the organic material. In this case, the detection of the weight and/or the size of the organic material can take place for example by means of measurement or by means of an input on the user side. Thus, for example, the organic material can be weighed or the length thereof, in particular a body length, can be measured. The amount of liquid and/or of oxygen to be filled in before and/or during the storage of the composting container, and/or the amount of composting substrate to be introduced, is then predetermined from the information then present regarding the weight and/or size, and thus for example also a body mass index (BMI for short), using control electronics.

The amounts predetermined via the control electronics can then be filled in or added manually. Alternatively, an automatic filling of the liquid and/or of the composting substrate can be provided.

In a variant, the amounts of one or more components of the composting substrate to be filled in are predetermined depending on a detected weight and/or a detected size of the organic material, for example also in an electronically assisted manner. A device used for composting the organic material can thus predetermine, based on an algorithm, what components and what amounts of said components of a certain composting substrate are to be filled into the composting container, depending on the weight and/or size of the organic material to be composted.

In a possible development, electronically controlled, automatic filling of the predetermined amounts of one or more components of the composting substrate via a device is possible. The corresponding amounts are then automatically filled into the composting container from reservoirs of the device, depending on the weight and/or size of the organic material.

A rotation of the composting container can for example take place about an angle in the range of 340° to 380° In the case of a thus complete or at least almost complete rotation of the composting container about the predetermined axis of rotation, undesired sinking and/or undesired clumping of the organic material during the composting process can be effectively counteracted. Alternatively, or in addition, in each case at least one rotation of the composting container can also take place at at least two different timepoints. It is also conceivable for the rotation of the composting container to take place for example first in one direction about the axis of rotation and (immediately) subsequently in the opposite direction about the axis of rotation. In this case, the angles can be for example at most +170° and −170°.

The at least one rotation can in principle take place in a manner actuated by external power. For this purpose, at least one drive motor of a (composting) device comprising the composting container is then provided. In this case, the drive motor can for example be accommodated entirely in a false floor of the composting container. The drive motor can, however, also be provided on a part of a device-side carrier frame for the composting container, in particular on a suspension device, and thus precisely not on the composting container itself.

A timepoint of the at least one rotation can be predetermined by means of control electronics of a device of this kind. In this case, a timepoint or a plurality of timepoints during the storage of the composting container can be firmly set. This for example includes a rotation taking place accordingly to a fixedly stored schedule (i.e. schedule independent of the organic material or according to a schedule defined variably in advance depending on the organic material to be composted). A corresponding schedule is then fixed e.g. at the start of the storage of the composting container. Alternatively, at least one rotation can take place at at least one timepoint during the storage, depending on at least one detected measured value, in particular depending on at least one measured value detected by sensor during the storage.

In the latter case above, a timepoint of the at least one rotation is then for example predetermined depending on at least one measured value acquired by sensors, which is representative for a (current) state, in particular for the current composting state, in the composting container. For this purpose, a device comprising the composting container comprises at least one sensor on the composting container and/or sensor means interacting with the composting container, via which at least one measured value is detected (directly or indirectly), via which a conclusion relating to the composting state is possible. The at least one measured value is then decisive for whether and when a rotation of the composting container takes place. For example, for this purpose a temperature, a water content and/or a gas composition in the composting container can be detected and evaluated.

For a composting process of organic material, maintaining a particular temperature level in the composting container has furthermore been found to be advantageous. In particular in combination with the defined addition of liquid and/or oxygen, and/or a specific rotation of the composting container, particularly effective composting can be achieved by maintaining a particular temperature level. Thus, for example, the content of the composting container is then held during storage in a predetermined temperature range via at least one heating element. In this case, the heating element can possibly be provided on the composting container itself, in particular integrated thereon. The heating element is furthermore electrically controllable, for example depending on at least one measured value acquired by sensors, which is representative for a current composting state in the composting container. The interior of the composting container is kept within a particular temperature range via the at least one heating element, for example in a range of 55° C. to 65° C., in particular in a range of 58° C. to 62° C. If a plurality of composting container are stored simultaneously, an individual heating element can be provided for each composting container.

In this case, maintaining a predetermined temperature level via at least one heating element, in particular via a heating element provided on the composting container itself, is advantageous irrespective of whether liquid is filled in and/or the composting container is rotated.

In principle, the composting time can (also) be predetermined depending on at least one measured value acquired by sensors, which is representative for a state, in particular a current composting state, in the composting container. It is thus possible to control, for example on the basis of measured values of a gas chromatograph, whether the composting time for the current organic material to be composted is reached, and for example whether an initially predetermined standard composting time has to be shortened or lengthened.

Post-processing of the content of the composting container after the composting time has elapsed can for example include sieving of the content and/or grinding of bone pieces from the originally introduced organic material that are still present in the content of the composting container. Thus, for example bone parts sieved out after sieving of the content of the composting container (i.e. of a first composting mixture resulting in the composting container after the composting time) can also be supplied to a bone mill. Bonemeal obtained thereby can be mixed with the sieved content of the composting container, in order to produce the plantable humus mixture.

The composting container can for example be mounted on a carrier frame of a (composting) device, for storage. The composting container can for example be rotatably mounted via a corresponding carrier frame and/or connected to (a) a corresponding liquid connection, (b) at least one power or signal line, and/or (c) a sensor means for detecting measured values representative for the state in the interior of the composting container.

In the context of a variant of the proposed method, after the composting time has elapsed, the composting container is removed from the carrier frame and fixed to a carrier of a post-processing station, on which the composting container is adjustably, in particular tiltably, mounted for removal of the content of the composting container from the composting container. At the post-processing station, the composting container is then for example tilted, such that the composted content of the composting container falls out and can be supplied to further post-processing steps, such as a sieving and/or grinding process.

A further aspect of the proposed solution relates is that of providing a device for composting organic material. A device proposed in this case comprises at least:
a composting container for the organic material to be composted and for a predetermined amount of a composting substrate comprising plant remains, and
a timer for specifying a composting time for which the composting container, comprising the organic material to be composted and the composting substrate, is to be stored (possibly preventing the introduction of additional organic material into the composting container), before a first composting mixture, which has resulted after the composting time, from the organic material and the composting substrate, inside the composting container, is post-processed for producing a plantable humus mixture.

A proposed (composting) device is now further characterized in that
at least one inflow opening is provided on the composting container, via which before and/or during the storage of the composting container a predetermined amount of liquid and/or oxygen can be filled into the composting container, and/or
the device comprises a carrier frame for the composting container, on which frame the composting container is mounted so as to be rotatable about an axis of rotation which is non-parallel to an effective direction of a weight force acting on the composting container, and/or
the device comprises at least one heating element, via which the content of the composting container can be held in a predetermined temperature range during storage.

A proposed device is therefore suitable in particular for carrying out a variant of a proposed (composting) method. Features and advantages of variants of a proposed method, which are mentioned above and, in the following, therefore also apply for variants of a proposed device, and vice versa.

Thus, a variant of a proposed device can for example comprise control electronics which are configured
to specify (for the timer) at least one timepoint during the storage at which a certain amount of liquid and/or oxygen is to be filled into the composting container, and/or
to control the filling of the liquid and/or the oxygen into the composting container during the storage via at least one inflow element, actuatable by external power, of an inflow system of the device that is coupled to the control electronics.

Part of the device is thus control electronics by means of which, for example, it is possible to signal when and what amount of liquid and/or oxygen is to be filled into the composting container. Alternatively or in addition, the control electronics can carry out the filling of the liquid and/or the oxygen automatically, and for this purpose for example actuate an inflow element, for example a flow regulating valve, in order to introduce liquid and/or oxygen into the composting container at at least one particular timepoint. In this case, an inflow element for filling oxygen into the composting container can be, in particular in part, an electronically controllable ventilation system of the device.

On a carrier frame of the device, the composting container can be rotatable about an angle in the range of 340° to 380° about the axis of rotation or about an angle up to 170° in one direction and up to 170° in the opposite direction, about the axis of rotation. For the rotation, the device for example comprises at least one drive motor, in particular a stepper motor, via which the rotation of the composting container on the carrier frame can take place in a manner actuated by external force. The timepoint of the at least one rotation can be predetermined by means of control electronics coupled to the drive device. As already explained above, a timepoint or a plurality of timepoints for the rotation can be firmly set or variably specified, for example depending on detected measured values, in particular detected by sensor during the storage.

For example, the device comprises at least one sensor via which at least one measured value can be detected which is representative for a (current) state, in particular for a current composting state, in the composting container. Using the at least one or more measured values of one or more sensors, control electronics of the device can then be configured to control, (on the basis of the at least one detected measured value),
filling of the liquid and/or the oxygen into the composting container, and/or
a rotation of the composting container on the carrier frame, and/or
the temperature range for the at least one heating element and/or the heating element, and/or
the composting time predetermined by the timer.

For example, in this case the control electronics are configured to control
the filling of the liquid and/or the oxygen into the composting container, and/or
the rotation of the composting container on the carrier frame, and/or
the temperature range for the at least one heating element and/or the heating element, and/or
the composting time predetermined by the timer, on the basis of machine-learnt control parameters.

It can thus be learnt by machine, for example from a plurality of composting processes carried out and sensor data detected in this respect, at what timepoints the filling of the liquid and/or of the oxygen, the rotation of the composting container, an increase or reduction of a temperature in the composting container, and/or a reduction or lengthening of a composting time, is decisive for achieving a particular composting result. In this case, measured data from a temperature sensor, moisture sensor and/or a gas chromatograph can then be used for a plurality of composting procedures carried out using a composting container, and/or can be included in measured data regarding composting procedures carried out using a plurality of composting containers.

In a variant, the device comprises a housing for the carrier frame which defines a receiving space in which the composting container, rotatably mounted on the carrier frame, is surrounded peripherally. In this case, the composting container, which can also be referred to in the following as “cocoon”, is for example accommodated individually in an aesthetically pleasing housing, in which the carrier frame is arranged. The composting container is then rotatable within said housing, in which the composting container is protected from being seen from the outside.

The housing can comprise at least one closure element which is mounted so as to be adjustable between an opening position and a closed position, in particular is pivotably mounted. In its opening position, the closure element releases an access opening on the housing, via which the composting container can be adjusted in the receiving space and can be rotatably mounted on the carrier frame. In the closed position of the closure element the access opening is closed, in particular closed in an opaque manner. Optionally, the composting container can be removed from the receiving space again, after the composting time, via the access opening which is accessible when the closure element is opened. Alternatively, an additional removal opening can be provided at another location of the housing.

In an alternative development, the device comprises a bearing unit comprising a plurality of (at least two) bearing points, wherein each bearing point comprises a carrier frame for rotatable mounting of a composting container. While, as a result, a housing explained above is configured and provided merely for accommodating one single composting container for example, a bearing unit provides the possibility of accommodating a plurality of composting containers. In this case, the bearing points can in particular be honeycombed. Access openings can be provided on a front surface of the bearing units, via which openings the individual bearing points are accessible for receiving composting containers. Of course, a bearing unit can also comprise a housing which is aesthetically pleasing, and which protects the bearing points for the composting containers. A housing of this kind can comprise wood paneling for example.

Irrespective of the type of mounding of the composting container during the storage, a variant can be provided in which the composting container comprises a cavity in a wall or in a floor element provided on an underside of the composting container, in which at least one electronic component and/or the at least one heating element are received. Thus, the composting container integrates at least parts of a sensor system and/or control electronics in the respective cavity.

Alternatively or in addition, parts of the control electronics, in particular also the majority of the control electronics, can be provided outside of the composting container, (a) for controlling filling of the composting container with liquid, (b) for rotating the composting container, (c) for heating the composting container, and/or (d) for ventilating or venting the composting container. In particular for this purpose the composting container can comprise at least one port for an electrical connection to a superordinate electronic controller of the device. Then, for example a transfer of control signals and/or the connection to a power supply can take place via a corresponding electrical connection. For example, a port of this kind allows a plug connection to the carrier frame and/or to a bearing point of a bearing unit.

A further proposed device comprises at least:
a composting container for the organic material to be composted and for a predetermined amount of a composting substrate comprising plant remains, and
a timer for specifying a composting time for which the composting container, comprising the organic material to be composted and the composting substrate, is to be stored, before a first composting mixture, which has resulted after the composting time, from the organic material and the composting substrate, inside the composting container, is post-processed for producing a plantable humus mixture,
   and is further characterized in that
at least one inflow opening is provided on the composting container, via which before and/or during the storage of the composting container a predetermined amount of liquid and/or oxygen can be filled into the composting container, and/or
the device comprises a carrier frame for the composting container, on which frame the composting container can be mounted, and/or
the device comprises at least one heating element, via which the content of the composting container can be held in a predetermined temperature range during storage.

For example, in a variant of a proposed device it can be provided that the composting container is mounted on the carrier frame so as to be rotatable about an axis of rotation which is non-parallel to an effective direction of a weight force acting on the composting container, wherein the carrier frame comprises bearing rollers for mounting the composting container. In this connection, the composting container can comprise a circular peripheral region on its outside, in at least one portion along the axis of rotation, which peripheral region interacts with the bearing rollers. The at least one circular peripheral region thus allows for rotation of the composting container about its axis of rotation on the bearing rollers of the carrier frame. In this case, the at least one circular peripheral region can be formed by a portion of an outside surface of the composting container itself. Alternatively, the at least one circular peripheral region can comprise an annular or ring-shaped (bearing) element, which extends around the composting container in the peripheral direction and the center point and axis of rotation of which coincides with the axis of rotation of the composting container. The annular or ring-shaped element can be configured as a separate element, which is fastened at least non-rotatably to the composting container.

Alternatively, it can be provided for the composting container to be mounted on the carrier frame such that it is not rotatable.

Irrespective of whether the composting container is mounted on the carrier frame rotatably or such that it is not rotatable, the device can comprise a drive device for rotation of the composting container in a manner actuated by external force. The drive device can for example comprise at least one drive motor, in particular a stepper motor, via which the rotation of the composting container can take place in a manner actuated by external force. The timepoint of the at least one rotation can be predetermined by means of control electronics coupled to the drive device. As already explained above, a timepoint or a plurality of timepoints for the rotation can be firmly set or variably specified, for example depending on detected measured values, in particular measured values detected by sensor during the storage, wherein the measured values are representative for the state of the content of the composting container.

In the case of the rotatable mounting of the composting container on the carrier frame, it is conceivable for the drive device to drive the composting container, while said container is rotatably mounted on the bearing rollers of the carrier frame. The drive device can for example be arranged on the carrier frame and be operatively connected to the composting container while the composting container is rotatably mounted on the carrier frame. It is also possible for the drive device to be mobile and, for the rotation of the composting container, to be brought (automatically) into the vicinity of thereof, such that the drive device and the composting container come into operative connection for the purpose of rotation of the composting container. In this case, the composting container can be rotatably mounted on the carrier frame while the drive device is operatively connected to the composting container. For example, the operative connection can comprise a magnet connection. In the case of the mounting of the composting container on the carrier frame such that it is not rotatable, it is conceivable for the drive device to drive the composting container while said container is not mounted on the carrier frame. In this variant, the device can further comprise a conveying means, which is provided for moving the composting container relative to the carrier frame between a first position and a second position, wherein the composting container is mounted as intended on the carrier frame in the first position, and is not mounted on the carrier frame in the second position. For the rotation of the composting container as intended, in its second position, the conveying means can comprise the drive device and a suitable bearing element. The conveying means can for example be configured as a stapler.

Mounted on the carrier frame, the composting container (in its first position) can be rotatable about an angle in the range of 340° to 380° about the axis of rotation or about an angle up to 170° in one direction and up to 170° in the opposite direction, about the axis of rotation. Also mounted at or on the conveying means, the composting container (in its second position) can be rotatable about an angle in the range of 340° to 380° about the axis of rotation or about an angle up to 170° in one direction and up to 170° in the opposite direction, about the axis of rotation. The rotation takes place by means of the drive device.

For example, the device comprises at least one sensor, via which at least one measured value can be detected which is representative for a (current) state in the composting container. Using the at least one measured value of the at least one sensor, control electronics of the device can then be configured to control one or more of the following aspects, on the basis of the at least one detected measured value:
filling of the liquid and/or the oxygen into the composting container,
a rotation of the composting container, in particular on the carrier frame,
the temperature range for the at least one heating element and/or the heating element,
the composting time predetermined by the timer.

For example, in this case the control electronics are configured to control the aspect(s) on the basis of machine-learnt control parameters.

In a variant, the device comprises a housing for the carrier frame which defines a receiving space in which the composting container, mounted on the carrier frame, is surrounded peripherally. The carrier frame is then arranged in the (aesthetically pleasing) housing, wherein an individual composting container can be accommodated in the housing. The composting container is then rotatable within said housing. The housing can be produced from an opaque material, such that the composting container is protected from view from the outside.

The housing can comprise at least one closure element which is mounted so as to be adjustable between an opening position and a closed position. The closure element can in particular be pivotably mounted. In its opening position, the closure element releases an access opening on the housing, via which the composting container can be adjusted in the receiving space and can be mounted on the carrier frame. In the closed position of the closure element, the access opening is closed. The closure element can also be opaque, such that the access opening is closed in an opaque manner in the closed position of the closure element. Optionally, the composting container can be removed from the receiving space again, after the composting time, via the access opening which is accessible when the closure element is opened. Alternatively, an additional removal opening can be provided at another location of the housing.

In a development, the device comprises a bearing unit comprising a plurality of (at least two) bearing points, wherein each bearing point comprises a carrier frame for the mounting of a composting container. The bearing unit offers the possibility of accommodating a plurality of composting containers. The bearing points can adjoin one another. For example, the bearing points can be arranged in a pattern, such that the bearing unit is as compact as possible. The bearing points can in particular be honeycombed. Access openings can be provided on a front surface of the bearing units, via which openings the individual bearing points are accessible for receiving and optionally removing composting containers. The bearing unit can also comprise a housing which is aesthetically pleasing, and which protects the bearing points for the composting containers. A plurality of composting containers can thus be accommodated in the housing. A housing of this kind can comprise wood paneling for example. One access opening can be provided per bearing point or composting container. The access openings can be released by closure elements of the housing, in their respective opening position.

Irrespective of the housing for the carrier frame, the device can comprise a decorative cladding for encasing a process container of the composting container. In this case, the decorative cladding is provided for individual encasing of a single process container (without carrier frame). Since it can be provided for the decorative cladding to be used only temporarily, the decorative cladding can be detachably connectable to the process container. Thus, the decorative cladding can be attached to the process container for example during a funeral ceremony, in particular before storage of the process container, and provided said container with an aesthetic appearance. For storage of the process container, the detachable connection can be released, and the decorative cladding removed.

In addition, or alternatively to the heating element, the device can comprise a conditioning unit which is configured to conduct a temperature-controlled gas or gas mixture into the composting container. Thus, the content of the composting container can be held in a predetermined temperature range during storage. (For the purpose of pressure equalization, the composting container comprises corresponding gas discharge devices.) For the purpose of temperature control within the composting container, the control electronics can control the temperature of the gas or gas mixture to be introduced into the composting container and/or the amount of gas or gas mixture to be introduced into the composting container, wherein the control electronics operates on the basis of temperature measured data of the sensor device. If a plurality of composting containers are stored simultaneously, then the conditioning unit can be provided as a central conditioning unit for all the composting containers (or a part thereof). In order to be able to design the temperature control by the conditioning unit individually for each composting container, in particular the amount of the respective gas or gas mixture to be introduced can be controlled.

It is conceivable for the gas which the conditioning unit introduces into the composting container(s) to be oxygen. The gas mixture can comprise oxygen or both oxygen and nitrogen, and in particular can be air. Thus, the oxygen content in the composting container(s) can be kept in a predetermined range, during the storage, by means of the conditioning unit. For the purpose of control of the oxygen content within the composting container(s), the control electronics can control the amount of the gas or gas mixture to be introduced into the composting container and/or the oxygen content of the gas mixture to be introduced into the composting container, wherein the control electronics operates on the basis of temperature measured data of the sensor device which determines the oxygen content within the composting container(s).

### BRIEF DESCRIPTION OF THE DRAWINGS

Possible variants of the proposed solution are illustrated in greater detail in the following in conjunction with the drawings, in particular with reference to possible usage scenarios by way of example.

FIGS. 1-2 are schematic views showing actions at the start and end of a burial process.

FIGS. 3-7 are schematic views showing steps of a method for composting organic material, which steps are carried out in preparation of the main decomposition process or the storage of the composting container used for the method.

FIG. 8 is a schematic view showing the procedures during the main decomposition process.

FIGS. 9-12 are schematic views showing steps of a method for composting organic material, which steps serve for processing the first composting mixture resulting during the main decomposition process.

FIG. 13 is a schematic view of a composting container according to one embodiment.

FIG. 14 is a plan view of the composting container from FIG. 13, wherein the composting container is shown in the open state without a closure element.

FIG. 15 is a sectional view of the composting container from FIG. 13, transversely to the axis of rotation thereof.

FIG. 16 is a schematic view of a composting container according to a further embodiment, in a state when mounted rotatably on a carrier frame.

FIG. 17 is a detail view of the composting container and the carrier frame from FIG. 16.

FIG. 18 is a perspective view of the composting container from FIG. 16.

FIG. 19 shows a device for composting organic material comprising a housing, wherein a closure element of the housing is located in the closed position.

FIGS. 20-22 are various perspective views of the device for composting organic material from FIG. 19, wherein the closure element of the housing is located in the opening position.

FIG. 23 is a detail view of the closure element from FIGS. 20 to 22, at the upper end thereof.

FIGS. 24-26 are detail views of the closure element from FIGS. 20 to 22, at the lower end thereof, comprising a shaft according to various embodiments.

FIG. 27 is a detail view of the closure element from FIG. 19, at the upper end thereof.

FIG. 28 shows a device for composting organic material comprising a plurality of composting containers, according to one embodiment.

FIG. 29 shows a device for composting organic material comprising a plurality of composting containers, according to a further embodiment.

FIG. 30 is a schematic view of a composting container according to a further embodiment.

FIGS. 31-33 are various perspective views of a process container according to one embodiment;

FIGS. 34-36 are various sectional views of the process container of FIGS. 31-33.

FIG. 37 is a perspective view of the process container of FIGS. 31-36, rotatably mounted on a carrier frame.

FIG. 38 is a perspective view of a bearing unit comprising a plurality of process containers and carrier frames from FIG. 37.

FIG. 39 schematically shows the procedures for preparing the process container of FIGS. 31-38 for the method step of storage.

FIG. 40 is a schematic view of facilities for carrying out the method for composting organic material.

### DETAILED DESCRIPTION

In the variants explained below of a proposed method, and variants, implementing these in each case, of a proposed device, the decomposition process of a human body can be reduced to 40 days or less. In this case, after completion of the funeral rituals, the corpse is placed in a special composting container (special type of coffin) and covered by a composting substrate (for short in the following: substrate). Optimal conditions (ratio of oxygen, temperature and moisture) can be provided for the microorganisms for decomposing organic material (human corpse), by the interaction among a coffin-like device, sensors, biological substrate, and an active control and regulation unit (control electronics). A suitable carbon/nitrogen ration is achieved by adding the substrate (inter alia plant remains from green waste, straw, etc.). In this case, the control and regulation systems can regulate the entire process, without neglecting the requirements of funeral parlors in the process.

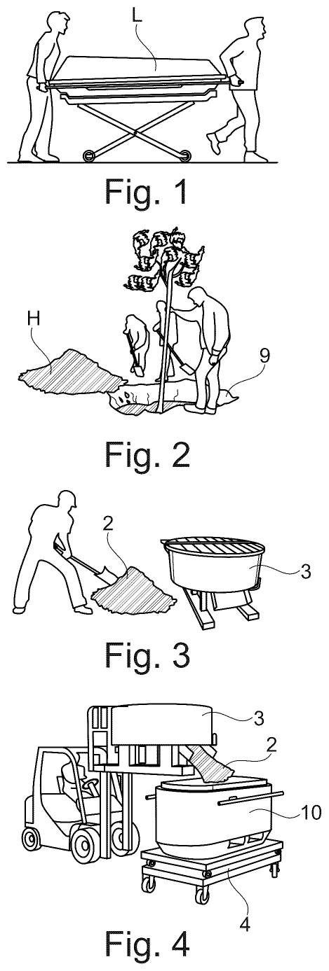

The method for composting organic material can be part of a burial process. The burial process begins when the death is recorded. Subsequently the (human) corpse, which, in the method described here for composting organic material forms the organic material, is collected by an undertaker, washed, dressed, placed in a coffin, and possibly prepared for lying in state. This is typically followed by a funeral ceremony, which takes place for example in a farewell room at the undertaker's, a chapel, or a church. After the end of the funeral ceremony, the undertaker transfers the corpse L, in the coffin, into a device in which the method for composting organic material is carried out (FIG. 1). This device can for example be located at or near a cemetery. By means of the method for composting organic material, initially a first composting mixture is produced. The first composting mixture produced by the method can be filled into a container having a ventilation option for post-decomposition, which can take up to two weeks. After completion of the post-decomposition, the resulting humus mixture H, mixed in part with earth, can be introduced into the ground of a gravesite, at a depth of approximately 30 cm, and covered by a layer of earth (FIG. 2). The humus mixture H can, if desired, be planted with a plant (e.g. tree). The post-decomposition can, however, take place in the ground of a gravesite, instead of in a container, and the composting mixture contained in the post-decomposition material can be planted.

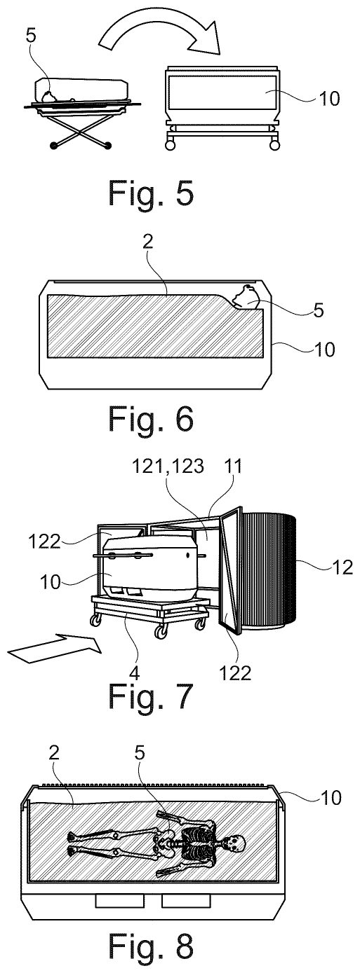

For the method for composting, a composting container 10 is used, which is explained in greater detail below. The method provides that firstly the organic material to be composted (corpse) 5 and a substrate 2 are filled into the composting container 10 (FIGS. 4 and 5).

The substrate 2 comprises plant tissue comprising at least two different types of plant remains. For example, the substrate 2 comprises one or more cereal products having a mass fraction in the range from 18% to 25%, a (further) plant remains having a mass fraction in the range from 18% to 25%, and additional biomass having a mass fraction in the range from 3% to 8%. The components of the substrate 2 preferably have a high energy content, in order to produce as much thermal energy as possible during the method, in particular during the storage step. Thus, the temperature of 60 to 70° C. desired for the storage can be achieved with minimal use of external energy sources. The components of the substrate 2 are dry and absorbent. For the purpose of odor absorption, the substrate 2 can also comprise biochar.

The volume or the weight of the individual substrate components is determined (assisted by software), depending on the weight or the body mass index of the corpse (of the organic material) 5.

For organic material 5 having a weight of approximately 75 kg, depending on the type and mixture of the plant tissue 120 to 200 kg substrate 2 are used. In addition, before the step of storage (explained below), 100 to 180 kg water are added to the substrate 2. In general, the water is added only shortly before filling the composting container 10, in order to prevent premature odor development (outside the closed composting container 10). During the storage, renewed addition of water into the composting container may be required.

All the parameters which are given or are selected in preparation for the storage are documented: Weight of the substrate 2, composition of the substrate 2, weight of the organic material 5, amount of water, total weight. These parameters may influence the duration of the storage.

The components of the substrate 2 are mixed (by means of a forced mixer, a feed mixer, or the like) and filled into a (mobile) filling device 3 (FIG. 3). The composting container 10 is filled, from the filling device 3, with approximately 50% of the prepared substrate 2. In this case, the filling device 3 can be height-adjustable, in order to raise it above the composting container 10 for the filling process. Thus, the substrate 2 can fall out of the filling device 3 into the composting container 10 (FIG. 4). The composting container 10 can be arranged, for and during the filling process, on a load lifting means 4 (e.g. lifting cart or lifting platform). Thus, the composting container 10 can be adjusted in height depending on the situation. As shown in FIG. 5, the organic material 5 (corpse) is transferred into the composting container 10 that is filled with half the amount of substrate, for example using a scoop stretcher. Finally, the remaining substrate 2 is filled into the composting container 10 over the organic material 5, such that the organic material 5 is completely covered by substrate 2 (FIG. 6).

As FIG. 7 shows, finally the composting container 10 is (rotatably) mounted at/on a carrier frame 11 of the device 1. In FIG. 7, the carrier frame 11 is surrounded, by way of example, by a housing 12 which defines a receiving space 121 which serves for receiving the carrier frame 11 and the composting container 10. The housing 12 comprises a closure element 122 which is mounted so as to be adjustable between an opening position in which an access opening 123 of the housing 12 is released, and a closed position in which the access opening 123 is closed. Via the access opening 123, the composting container 10 is adjusted in the receiving space 121 and mounted at/on the carrier frame 11. For this purpose, it may be necessary to raise the composting container 10, for example using the load lifting means 4. The height to which the composting container 10 is raised can be between 55 and 75 cm, for example approximately 62.5 cm. After the composting container 10 has been mounted as intended at/on the carrier frame 11, the load lifting means is removed and the connections (explained in greater detail in the following) to control and regulation devices, sensor devices, irrigation and gas lines are established.

The step of storage of the composting container 10 subsequently takes place. During the storage, the main decomposition process of the organic material 5 takes place. For example, a sensor for detecting the composting container 10 can be provided. The sensor can for example comprise weighing cells or the like. As soon as the sensor detects that the composting container 10 is mounted as intended at/on the carrier frame, the main decomposition process is started.

In the main decomposition process, the organic material 5 decomposes, and a first composting mixture results (FIG. 8). The main decomposition process lasts on average up to 40 days, but routinely approximately four weeks.

During the main decomposition process, the composting container 10 remains closed, in order, in case of doubt, not to contravene statutory provisions regarding peace in death. For example, the composting container remains closed for 40 days. Accordingly, the composting container 10 is also not opened for monitoring the main decomposition process. The monitoring therefore takes place via the sensor devices, which monitor parameters relevant to the main decomposition process (temperature, moisture, pH, content of gases (oxygen, carbon dioxide, carbon monoxide, methane, hydrogen sulfide, ammonia)) during the storage. The parameters are optionally regulated by means of control and regulation devices. If the measured values of the parameters deviate from predetermined limit values, an error message can be generated, which is displayed to a user (visually, acoustically). The content of the gases can be monitored by means of a gas chromatography device. The data of the gas chromatography device can deliver information relating to the progress of the main decomposition process, and in particular also signal the end of the main decomposition process. Thus, the duration of the storage can be optimally adjusted to the duration of the main decomposition process.

During the storage, the composting container 10 is occasionally rotated about its axis of rotation D. The rotation prevents the organic material 5 from sinking and/or prevents clumping of the content of the composting container 10 as a whole. The timepoint for a rotation process is determined on the basis of the measured data of the sensor devices, which are representative for the state in the composting container 10 and for the progress of the main decomposition process. The rotation process is then triggered by means of the control and regulation devices. A rotation process can for example comprise two to three consecutive rotations of the composting container 10 about 360° in each case. During the rotation, the composting container 10 can be mounted on the carrier frame 11. During the storage, the content of the composting container 10 can be ventilated and watered as required. The timepoint and amount are determined on the basis of the measured data of the sensor devices, which are representative for the state in the composting container 10 and for the progress of the main decomposition process. The main decomposition process preferably takes place at a temperature between 6° and 70° C.

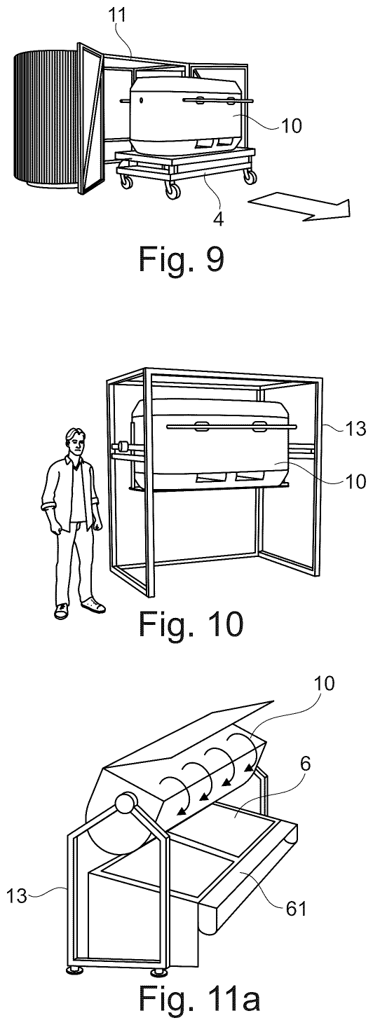

At the end of the main decomposition process, the composting container 10 is separated from the carrier frame 11 and optionally moved by the load lifting means 4 to a different location (FIG. 9) for the purpose of emptying. The composting container 10 is subsequently rotatably mounted on the operating frame 13 and is tilted in order to empty the composting container 10 (FIG. 10). Alternatively, the composting container 10 can be mounted at/on the carrier frame 11 during emptying.

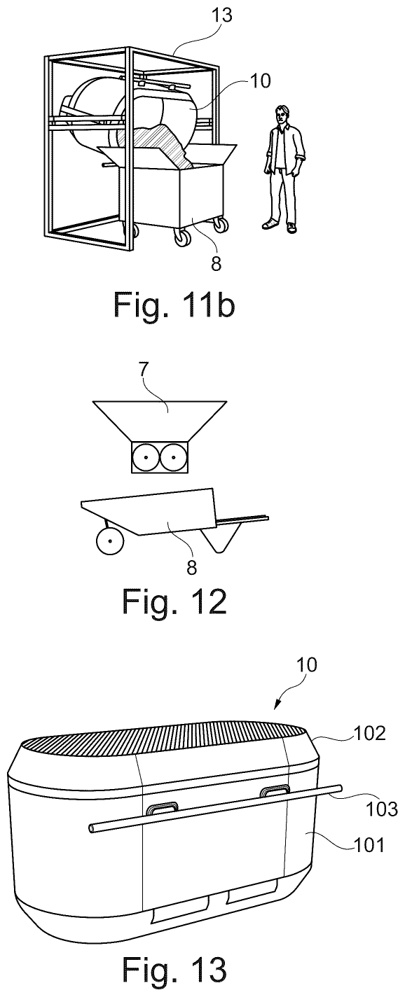

During emptying, the content of the composting container 10 passes into a sieve 6, in order to separate out non-composted/non-compostable fractions of the organic material (bones, prosthetics, metal fillings, pacemakers) from the composting mixture (FIG. 11a). The sieve 6 can be a vibrating sieve and comprise a channel 61 (for example having a capacity of 20-30 l). The substrate 2 and the composted organic material fall through the sieve 6 and are collected in a post-decomposition container. The remaining components are collected in the channel 61. The non-composted and the non-compostable fractions can be studied using image analysis techniques in order to separate organic fractions from inorganic fractions. The sieve 6 can be magnetic or comprise magnetic rollers, in order to separate metal elements. Prosthetics, metal fillings and pacemakers are recycled if possible.

Alternatively, the content of the composting container 10 is transferred into a transport container 8 (FIG. 11b). Subsequently, the content is transferred into a mixing device and mixed thoroughly there. The thoroughly mixed first composting mixture is removed from the mixer (via an outlet slide) and conducted through a sieve 6, as described above. The substrate 2 and composted organic material are collected in a post-decomposition container. The non-composted/non-compostable fractions of the organic material are separated.

Following the two scenarios (FIGS. 11a, 11b), the bones are ground in a mill (impact mill, bone mill, oat crusher, flour mill, grape press) (FIG. 12) and mixed, in ground form, into the substrate and the composted organic material. The mill 7 can be configured as an attachment on a mixer.

The composting mixture thus obtained undergoes a post-decomposition process. The post-decomposition process lasts up to two weeks. For the post-decomposition process, rock flour and/or powdered clay can be added to the composting mixture, such that a humus mixture results. The rock flour and/or powdered clay accelerates the post-decomposition process and reduces the activity of the composting mixture. The rock flour and/or powdered clay, as well as water, can be mixed with the composting mixture with the aid of the mixer or manually. During the post-decomposition process, environmental parameters such as temperature, humidity, air supply, are monitored. The post-decomposition process can take place in a post-decomposition container which is filled with 0.5 to 1 m³ of earth. The post-decomposition container can be a burial container or a (double-walled) (plastics) container, preferably having a ventilation option. The post-decomposition container can be taken to a gravesite following the post-decomposition process. Alternatively, the post-decomposition process can take place in the ground of the gravesite. For this purpose, the first composting mixture is introduced into the ground at a depth of approximately 30 cm, mixed with earth, and covered with a layer of earth.

The emptied composting container 10 and the carrier frame 11 are cleaned (by machine, fully automatically) and are available again for the method for composting organic material.

The method steps described can take place in a fully automatic manner.

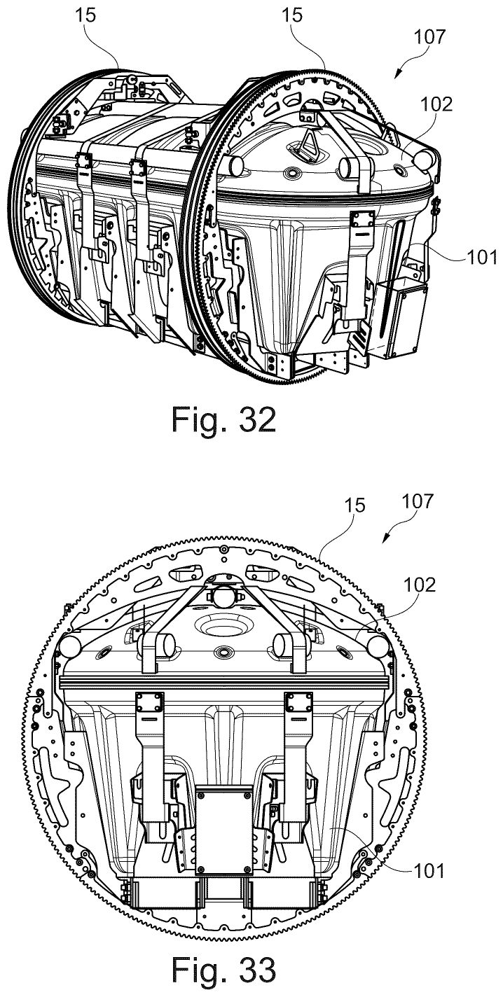

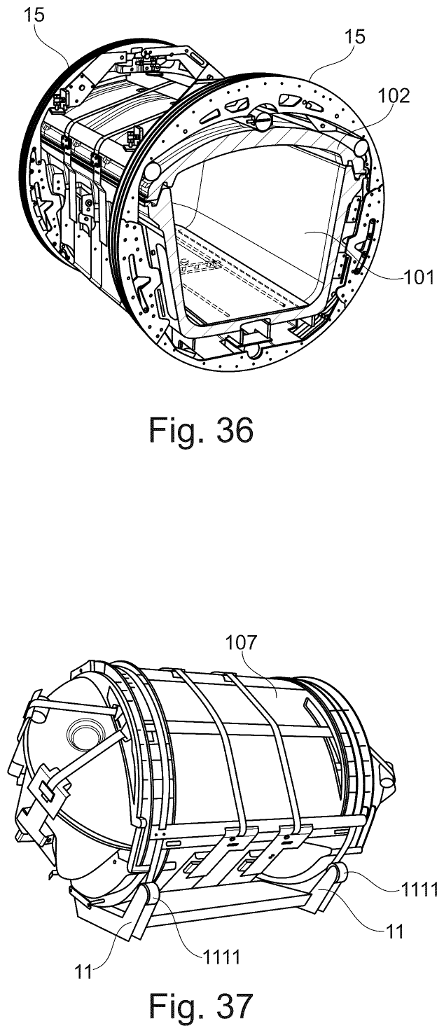

In the following, variants of the device 1 for composting organic material will be described with reference to FIGS. 13 to 38. The device 1 first comprises the composting container 10 already mentioned in connection with the method, and the carrier frame 11 at/on which the composting container 10 is mounted. FIG. 13 shows a variant of the composting container 10 in its closed state. In the closed state, the composting container 10 has an internal volume of over 1 m³, in particular 1.1 m³. Said internal volume can be provided for receiving approximately 0.1 m³ of organic material 5 (corpse) and approximately 1 m³ of substrate, which results in approximately 500 l of the first composting mixture.

The composting container 10 comprises a receiving element 101 for receiving the substrate 2 and the organic material 5 to be composted, and a closure element 102 for closing the receiving element 101. A handrail 103 is arranged on each of the longitudinal sides of the receiving element 101. The receiving element 101 comprises a base (base element) 1012 and a casing (casing element) 1013. On its side remote from the base 1012, the casing 1013 defines an access opening 1011 of the receiving element 101.

The closure element 102 is pivotably (for example by a hinge) fastened to the receiving element 101, such that the closure element 102 can be pivoted, relative to the receiving element 101, between a first position and a second position. In the first position, the closure element 102 completely closes the receiving element 101. If the closure element 102 is in the first position, it can be fastened to the receiving element 101 by means of a suitable closing device 109, such that the closure element 102 cannot move relative to the receiving element 101. For the method step of storage, already described, the closure element 102 is in the first position. In the second position, the closure element 102 releases the access opening 1011 of the receiving element 101. The substrate 2 and the organic material 5 (in preparation for storage) can be introduced into the receiving element 101 via the access opening 1011.

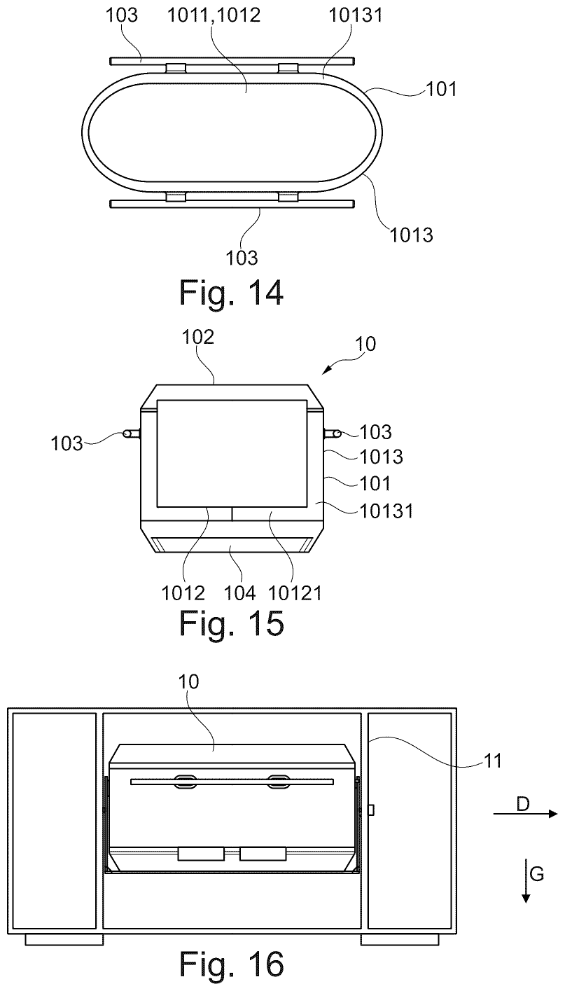

Alternatively, it can be provided that the closure element 102 can be completely released from the receiving element 101, in order to release the access opening 1011 of the receiving element 101. FIG. 14 is a plan view of the receiving element 101 and the access opening 1011 thereof, wherein the closure element is separated from the receiving element 101.

A membrane or a biofilter can be arranged on an inside of the closure element 102, in order to bind odors. In the base 1012 of the receiving element 101 an opening for a biofilter, which serves to prevent the escape of seepage water, odors or dust, can be provided.

In order to carry out the main decomposition process, it is necessary to keep the temperature, the oxygen content and the moisture within the composting container 10 within predetermined limits, and to regularly rotate the composting container 10. The monitoring of the weight of the filled composting container 10 during the main decomposition process may also be expedient. Therefore, the composting container 10 comprises at least one connection to an irrigation line and also an outlet valve (optionally having an outlet line), in order to evacuate excess water. The connection to the irrigation line is in particular formed on the closure element 102 of the composting container 10. The irrigation line can for example comprise a drip or pearl hose. For ventilation (supply of air or pure oxygen) of the composting container 10, a fan is for example installed in the closure element 102 or in the casing 1013 of the receiving element 101. The fan can either supply air from the surroundings, or pure oxygen which is provided via a corresponding gas line. A heating element heats the composting container 10 as required. A drive motor 14 for rotation of the composting container 10 in a manner actuated by external power is for example provided on the carrier frame 11. In order to monitor the weight, a weighing cell 16, which is arranged for example between the carrier frame 11 and the composting container 11, or a pallet scale or weighbridge, which is pushed under the composting container for determining weight (manually or automatically), can be provided.

The connection to the irrigation line, the outlet valve, the fan, the heating element, and the drive motor 14 are in particular configured to be controllable and interact with a control and regulation device (sensor electronics). In this case, the control and regulation device operates on the basis of measured data which it acquires from sensor devices. The sensor devices acquire parameters which allow for conclusions to be drawn regarding the temperature, the moisture, the pH, the content of various gases (for example oxygen, carbon dioxide, carbon monoxide, methane, hydrogen sulfide, ammonia) within the composting container 10. The measured data of the sensor devices allow for conclusions regarding the progress of the main decomposition process. The sensor devices are arranged on or in the composting container.

The mentioned components are supplied with power via electrical lines, which are or have to be compatible with the occasional rotation of the composting container 10. The electrical lines can therefore be configured as coiled cables (with or without a drum) and laid via a shaft, design as a hollow shaft, of the bearing device 111 explained below. The use of a slip ring is also conceivable. Likewise, the irrigation line, outlet line and gas line can also be configured as spiral hoses and laid by the hollow shaft.

FIG. 15 is a sectional view of the composting container 10 from FIG. 13. Under the base 1012 of the receiving element 101, the composting container 10 comprises a receptacle 104 which serves for receiving components of the control and regulation devices, the sensor devices, the water and gas lines, the heating device, and/or the drive device. The receptacles 104 can have a height of 180 to 200 mm.

The base 1012 and the casing 1013 have a (thermal) insulation layer 10121, 10131. The thickness of the insulation layer 10121, 10131 can be 80 to 100 mm. Locally, the thickness of the insulation layer 10121, 10131 can be reduced, for example at the heat and foot sides (which extend between the longitudinal sides) of the casing 1013, in order not to exceed the maximum possible length of the receiving element 101. There, the thickness of the insulation layer 10131 can be approximately 50 mm. The length of the receiving element 101 and thus of the composting container 10 is preferably at most 2100 mm. The width and the height of the composting container 10 are in each case for example 700 mm.

In the embodiment of FIG. 16, the composting container 10 is mounted on the carrier frame 11 so as to be rotatable about an axis of rotation D. The axis of rotation D extends in parallel with the longitudinal axis of the composting container 10. The carrier frame 11 comprises a bearing device 111 for mounting the composting container 10. The bearing device 111 can comprise two units, wherein each unit interacts with the composting container 10, for the purpose of mounting, at its head and foot ends, on the bearing points 105. The bearing device 111 can comprise a shaft.

The bearing device 111 is arranged in terms of height such that the composting container 10 is mounted suspended on the carrier frame 11. In this case, the lower edge of the composting container 10 is for example at a spacing of 600 to 700 mm, in particular 625 mm, from the lower end of the carrier frame 11 or the ground on which the carrier frame 11 is positioned. This height allows for use of conventional load lifting and transport means in the funeral service, in order to mount the composting container 10 on the carrier frame 11.

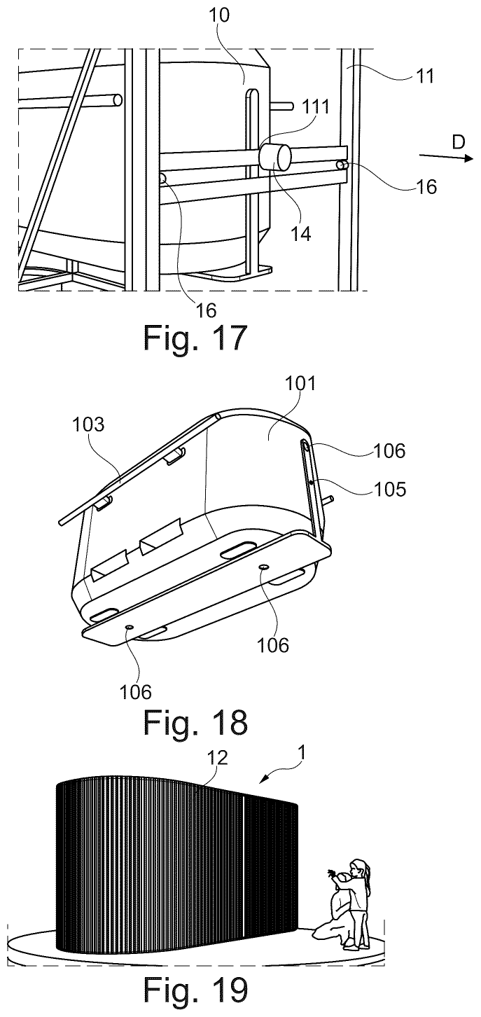

As FIG. 17 shows, a drive motor 14 is arranged on the carrier frame 11, which motor is provided for rotating the composting container 10 about the axis of rotation D. In this case, the speed of rotation is less than three rotations per minute, for example one rotation per minute or two rotations per minute. The drive motor 14 can be configured as a stepper motor or as a motor having a frequency inverter. The embodiment as a motor having a frequency inverter can offer the advantage that the speed of rotation can be adjusted using simple means. The rotational movement generated by the drive motor 14 can be transmitted to the composting container 10 by means of V-belts or by means of gearwheels and chain.

Alternatively, the drive motor 14 can be arranged in the receptacle 104. Since the receptacle 104 is part of the rotatable composting container 10, the drive motor 14 can be connected via coiled cables to a power supply means.

FIG. 18 once again shows the composting container 10 without the carrier frame, in a perspective view. The bearing point 105, on which the bearing device 111 engages for mounting the composting container 10, is visible at the head or foot end of the receiving element 101. In order to prevent a rotation of the composting container 10 and to lock the composting container 10 in a defined position, locking elements 106 are provided at the head and foot ends and on the underside of the composting container 10. The number and position of the locking elements 106 are merely by way of example in FIG. 18. For the purpose of locking, the locking elements 106 can assume an extended position, in which they come to rest on the carrier frame 11 or on the ground.

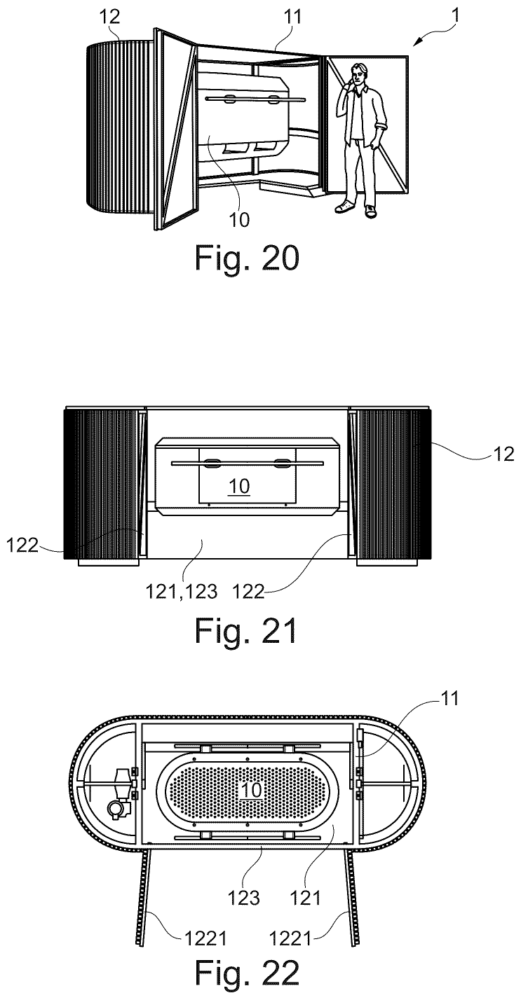

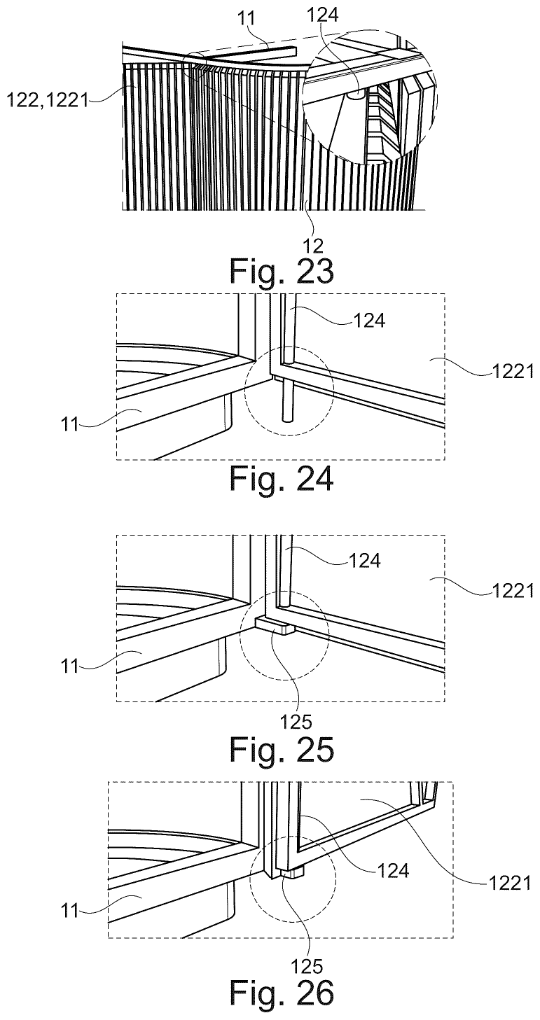

The carrier frame 11 also serves to hold the housing 12. The housing 12 can be configured to be decorative and can comprise for example natural materials, such as wood, in order to conceal the technical nature of the device 1. An example for a housing 12 is shown in FIGS. 19 and 20. The housing 12 comprises a closure element 122 which is formed in two parts and is shown in FIG. 19 in its closed position and in FIG. 20 in its opening position. FIGS. 21 and 22 show the opening position once again, in a front view and a plan view.

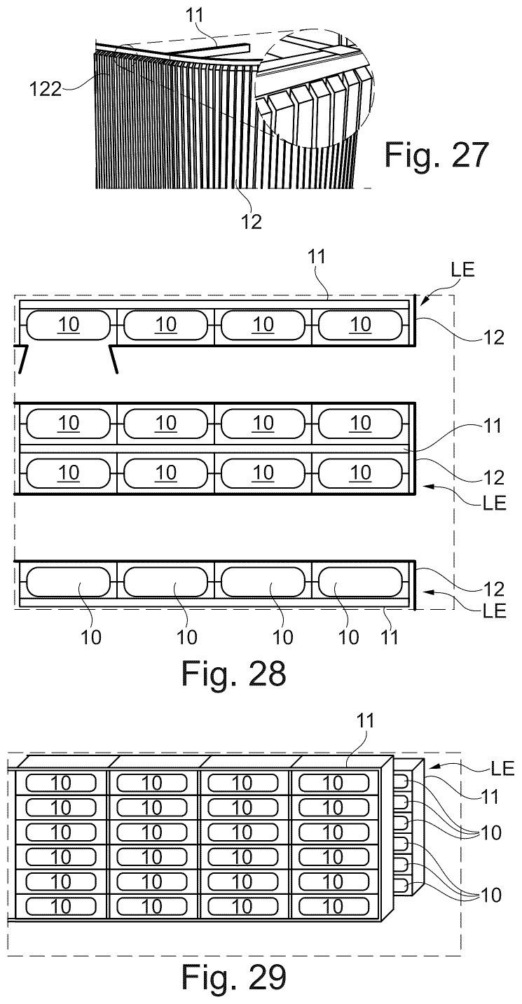

The closure element 122 comprises two rotatably mounted doors 1221 which, in the opening position, release an access opening 123 to a receiving space 121 which is surrounded by the housing 12. Via the access opening 123, the composting container 10 can be adjusted in the receiving space 121 and rotatably mounted on the carrier frame 11. The doors 1221 are in each case arranged on a vertically extending shaft 124, which is rotatably mounted on the carrier frame 11 (FIGS. 23 to 26). FIG. 23 shows that the upper end of the shaft 124 is guided through a receptacle of the carrier frame 11. FIGS. 24 to 26 show different possibilities for a lower termination of the shaft 124. In FIG. 24, the lower end of the shaft 124 is free. In FIGS. 25 and 26, the lower end of the shaft 124 is mounted on a bearing block 125, which is fastened to the carrier frame 11 or to the door 1221 of the closure element 122. In the closed position of the housing 12, the closure element 122 together with the remaining housing 12 forms a uniform surface (FIG. 27). The doors 1221 can close via a catch which can be opened by means of a key.

As already mentioned, the device 1 comprises a series of sensor devices and control and regulation devices, in order to monitor the main decomposition process and optionally be able to influence the progress of the main decomposition. Said sensor, control and regulation devices can be arranged on the composting container 10 and/or on the carrier frame 11. In the embodiment of FIGS. 13 to 27, these devices can be arranged half each on the composting container 10 and on the carrier frame 11. In order to make the composting container 10 lighter in weight and for handling, the majority of these devices can be relocated onto the carrier frame 11.

The variants of the device 1 set out hitherto relate to a composting container 10 which is mounted individually on a carrier frame 11 and can be surrounded by an individual housing 12. FIG. 28 shows an embodiment in which a plurality of composting containers 10 are combined in one bearing unit LE. The bearing unit LE comprises a plurality of bearing points, wherein each bearing point comprises a carrier frame 11 for the rotatable mounting of a composting container 10. In FIG. 28, a bearing unit LE comprises for example four or eight bearing points. The number of bearing points per bearing unit can be significantly higher, however, for example 20 to 50. The carrier frames 11, which each comprise a bearing device 111 for the rotatable mounting of one composting container 10 in each case, can be connected to one another. In FIG. 28 for example four or eight carrier frames 11 are interconnected and in each case form a bearing unit LE. However, the carrier frames 11 of a bearing unit LE may also not be interconnected.

The sensor, control and regulation devices, which are required for monitoring each composting container 10, can be bundled or can merge centrally, in order to simplify the monitoring of the composting containers 10 of the bearing unit LE. In the embodiment of FIG. 28, approximately 30% of the sensor, control and regulation devices are arranged on the composting containers 10, and 70% on the carrier frames 11.

The composting containers 10 are spatially close to one another in a bearing unit. As a result, the waste heat of one composting container 10 can be used for heating the surrounding composting containers 10. Each bearing unit LE has its own housing 12. The housing 12 can comprise one closure element 122 per composting container 10. The composting containers 10 are all arranged at the same height. A hall is provided for accommodating the bearing units LE. Depending on the size of the bearing units LE, the hall can also receive only one bearing unit LE.

The device 1 from FIG. 28 is suitable, just as the variants of FIGS. 13 to 27, which relate to individually housed composting containers 10, for carrying out the method for composting already described. The main decomposition process takes place in each composting container 10 independently of the remaining composting containers 10 of the bearing unit LE. In this case, the sensor, control and regulation devices can measure and regulate the parameters of each main decomposition process individually. The regular rotation of the composting containers 10 can also take place individually. At the end of the main decomposition process in one of the composting containers 10, said composting container 10 is removed from the carrier frame 11 by means of a load lifting means 4 (without in the process disturbing the other composting containers 10 and the main decomposition processes taking place therein) and mounted on an operating frame 13 for processing the first composting mixture.

FIG. 29 shows a further embodiment in which a plurality of composting containers 10 are combined in one bearing unit LE. In this embodiment, the carrier frames 11 are configured such that the composting containers 10 can also be arranged stacked. The composting containers 10 are thus no longer located at one height, but rather can be arranged both side-by-side and one above the other. Since the available surface can thus be used efficiently, one bearing unit 50 can comprise up to 200 composting containers 10. A bearing unit LE of this kind (or a plurality thereof) can be accommodated in a hall. In the embodiment of FIG. 29, approximately 15% of the sensor, control and regulation devices are arranged on the composting containers 10, and 85% on the carrier frames 11. In order to mount the composting containers 10 as intended on the respective bearing device 111, a (vertically and horizontally controllable) robot can be provided, which places the composting containers 10 accordingly. The robot can furthermore serve to remove the composting containers 10 from the carrier frames 11 again at the end of the main decomposition process, and for example move them into a processing room, where the content of the composting containers 10, as already described, are processed and undergo the post-decomposition process.

During the main decomposition process, the composting container 10, in the embodiment from FIG. 29, is mounted along with a plurality of others on the associated carrier frame 11. Furthermore, the composting container 10 is not necessarily located close to the ground. Therefore, the mourners' funeral ceremony should not take place in the direct vicinity of the composting container 10 during the main decomposition process. For example, the funeral ceremony can take place before the main decomposition process (close to the composting container or the corpse that is placed in a coffin elsewhere), and during the main decomposition process in a separate room without the composting container.

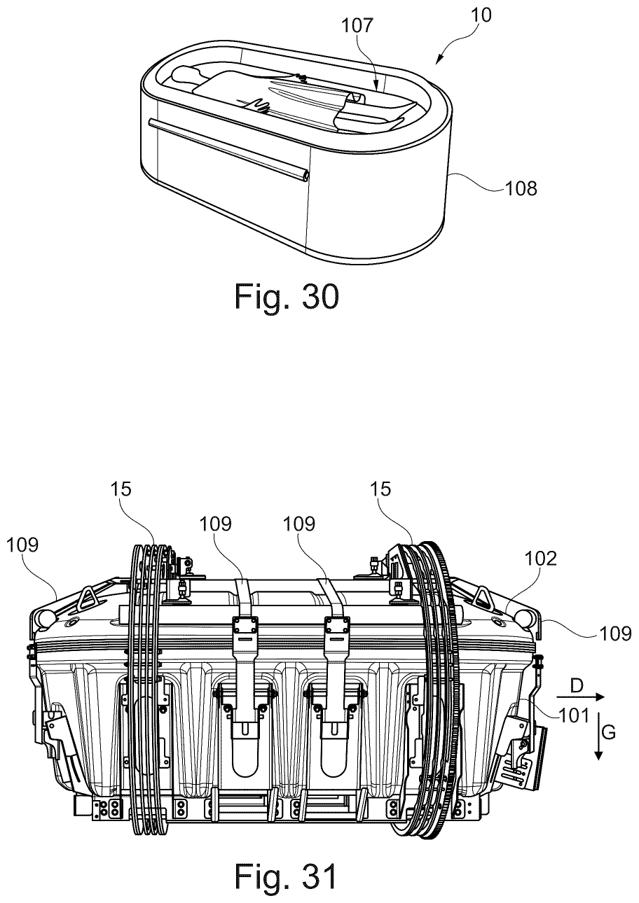

FIG. 30 shows a composting container 10 according to a further embodiment, without a closure element. The composting container 10 comprises a process container 107 and a decorative cladding 108. The process container 107 is used for the method step of storage. The main decomposition process takes place therein. The decorative cladding 108 serves for cladding the process container 107, in particular during a funeral ceremony. The decorative cladding 108 can be detachably fastened to the process container 107. During the storage of the composting container 10, the decorative cladding 108 is separated from the process container 107. The decorative cladding can be formed in one piece and clad the receiving element 101 and the closure element 102, which is located in its first position and completely closes the access opening 1011 of the receiving element 101, together. Alternatively, the decorative cladding 108 can be formed in at least two parts, and thus clad the receiving element 101 and the closure element 102 individually in each case. The latter alternative offers the possibility of using the composting container 10 selectively open or closed, during the funeral ceremony.

The division of the composting container 10 into the process container 107 and decorative cladding 108, as described in connection with the embodiment of FIG. 30, can also be applied to the embodiments described hitherto of the device for composting organic material (FIGS. 13 to 29).

FIGS. 31 to 33 are various perspective views of the composting container 10 from FIG. 30 without the decorative cladding, but with the closure element 102. The closure element 102 is located in its first position on the receiving element 101 and in this case completely closes the access opening 1011 of the receiving element 101. With the aid of a closing device 109, the closure element 102 is held firmly on the receiving element 101, such that the closure element 102 cannot detach from the receiving element 101, in particular upon rotation of the process container 107 during the main decomposition process.

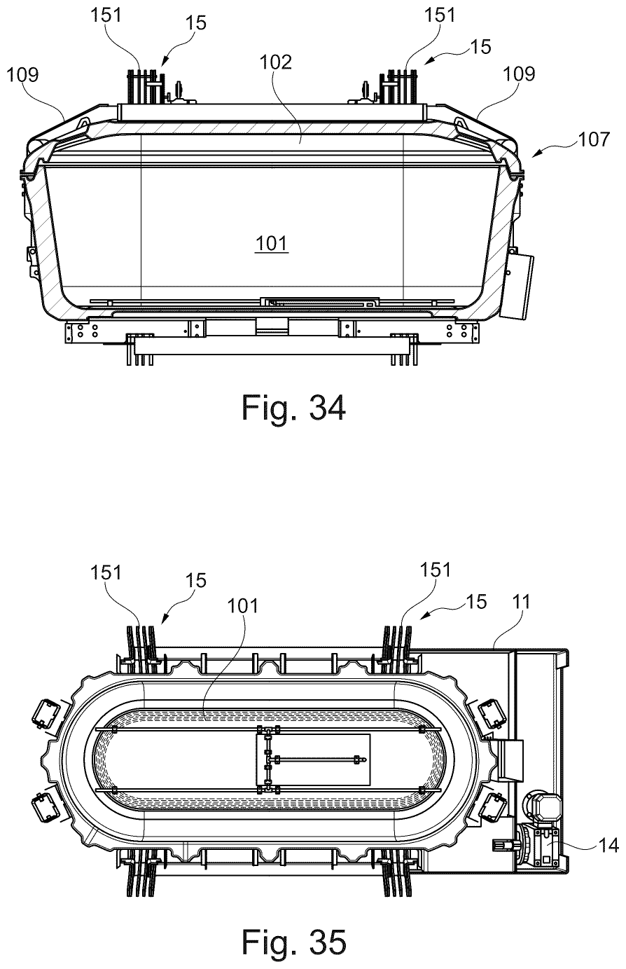

Two annular bearing elements 15 are arranged on the process container 107 (on the outside thereof). In this case, the annular bearing elements 15 have the same radius, and their center points are positioned on the axis of rotation D of the process container 107. The two annular bearing elements 15 are offset along the axis of rotation D. In this case, the annular bearing elements 15 are located on either side of a plane which extends perpendicularly to the axis of rotation D and is located at half the height of the process container 107. The number of annular bearing elements 15 is only by way of example in this embodiment. In principle, there could be two, or more than two, annular bearing elements 15. The radius of the annular bearing elements 15 is selected depending on the outside contour of the process container 107 in such a way that the spacing between the process container 107 and the annular bearing elements 15 is as small as possible (FIG. 33). Each annular bearing element 15 comprises four wheels 151 which are arranged offset along the axis of rotation D and which can be connected to one another. In this case, the spacing between two adjacent wheels 151 of an annular bearing element 15 is significantly smaller than the spacing between the two annular bearing elements 15 (FIG. 34). The number of wheels per annular bearing element 15 can deviate from four. The annular bearing elements 15 are non-rotatably connected to the process container 107. At least one of the wheels 151 per process container 107 is configured as a gearwheel. The gearwheel can interact with a drive device 14 (with corresponding components of a drive motor), in order to rotate the process container 107 about its axis of rotation D. The drive device 14 is arranged for example on the carrier frame 11, as shown in FIG. 35. The process container 107 is rotatably mounted on the carrier frame 11 (FIG. 37). For this purpose, the carrier frame 11 comprises bearing rollers 1111 which are part of the bearing device 111 of the carrier frame 11. The bearing rollers 1111 interact with the annular bearing elements 15.

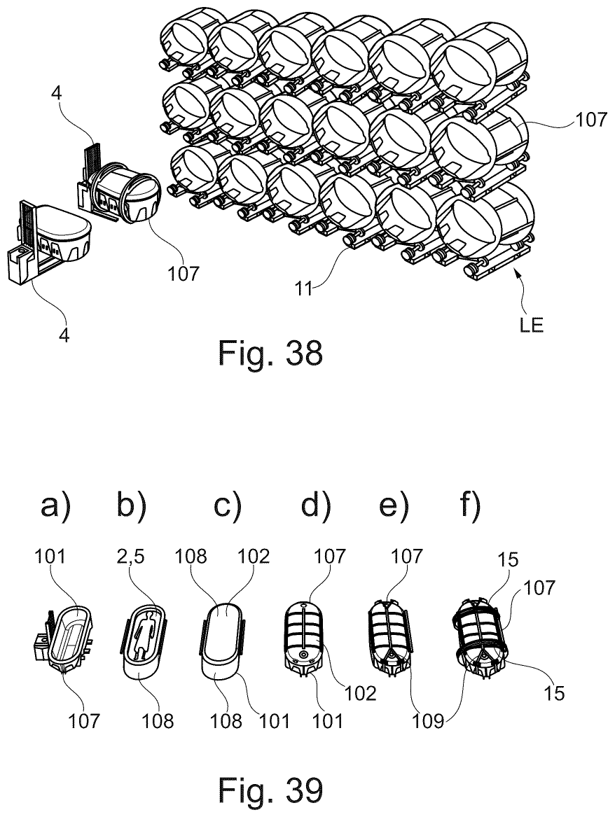

FIG. 38 shows a plurality of carrier frames 11 from FIG. 37, each comprising a process container 107. The carrier frames 11 are arranged there side-by-side and one above the other, and form a bearing unit LE. The arrangement of the carrier frames 11 is merely by way of example. FIG. 38 furthermore shows two load lifting means 4, each comprising a process container 107. The load lifting means 4 are used for placing a process container 107 for the main decomposition process on the associated bearing point of the bearing unit LE, and for removing the process container 107 from the bearing point again at the end of the main decomposition process. In addition, the load lifting means 4 can be equipped with a drive device, which is provided for rotating the process container 107 about the axis of rotation D thereof, while the process container 107 is rotatably mounted on the carrier frame 11. It is thus possible to omit equipping each carrier frame 11 with a drive device, and thus providing an individual drive device for each process container 107.

In one embodiment, the process container 107 is mounted on the carrier frame 11 such that it is not rotatable. In this case, the drive device of the load lifting means 4 serves to rotate the process container 107 while the process container 107 is rotatably mounted on the load lifting means 4 or otherwise.

Not only the drive device can be provided centrally for a plurality of process containers 107. A central (air) conditioning unit can also serve for supplying a plurality or all of the process containers with air or pure oxygen. The air conditioning unit can thus replace individual fans for each process container 107. The (air) conditioning unit can further be configured to control the temperature of the air/oxygen to be supplied, such that furthermore heating elements, which were to be provided specifically for each process container, can be omitted.

The control processes to be performed by the control and regulation devices can be divided into main control and logistics control. In this case the main control relates to all the parameters that are relevant for the successful course of the main decomposition process (temperature, moisture, content of various gases (for example oxygen, carbon dioxide, methane, hydrogen sulfide) in the process container 107). The logistics control controls the operation of the load lifting means, in particular their location of use and time of use.

FIG. 39 shows in image a) an empty receiving element 101 of a process container 107. The process container 107 is provided with a decorative cladding 108 and filled with the substrate 2 and the organic material 5 (image b)). In image c), the closure element 102 is placed together with the decorative cladding 108 on the receiving element 101, for example for a funeral ceremony. Image d) shows the process container 107 (receiving element 101 and closure element 102) finally (after the funeral ceremony) again without the decorative cladding. In image e) the receiving element 101 and the closure element 102 are firmly interconnected by means of the closing device 109, such that they cannot detach from one another or slide against one another upon rotation of the process container 107. Image f) finally shows the arrangement as intended of the annular bearing elements 15 on the process container 107. The process container is now prepared as intended for the step of storage and can be mounted on the carrier frame (individually or within a bearing unit LE) by means of a load lifting means.

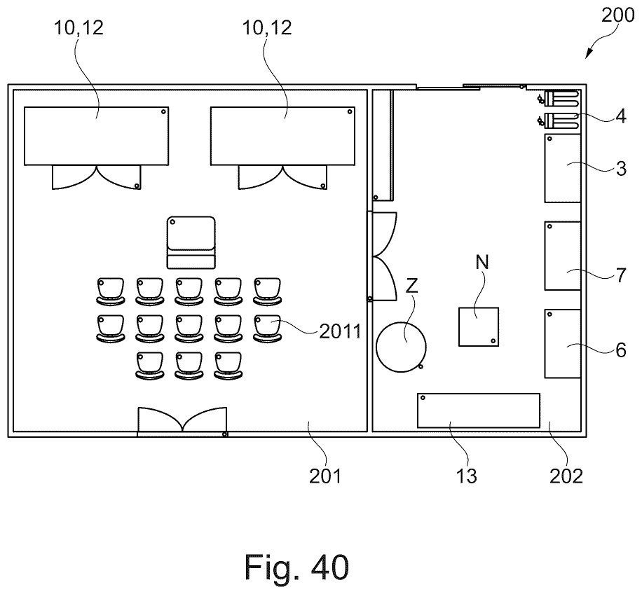

FIG. 40 is a schematic view by way of example of facilities 200 for carrying out the method for composting organic material 5. Firstly, what is known as a re-burial room 201 is provided, in which in this case, by way of example, the individual composting container 10 (with housing 12) is located at least for the main decomposition process. Sufficient space (0.5 m) is to be provided around the composting container, in order that good air circulation is possible. In this connection, the re-burial room should have a height of at least 3.5 m. Furthermore, space of at least 3 m is to be provided for manipulation (fastening of the composting container at/on the carrier frame, rotation of the composting container). The funeral ceremony can thus also take place in the re-burial room 201. Accordingly, seats 2011 and a lectern 2012 are also accommodated there.

Furthermore, a processing room 202 is provided, in which the first composting mixture, which is obtained at the end of the main decomposition process, is processed. The preparation of the substrate 2 and the filling of the composting container can also take place in the processing room 202. All the equipment for preparation and follow-up is accommodated in the processing room 202 (sieve 6, mill 7, load lifting means 4, post-decomposition container N, operating frame 13, forced mixer Z, filling device 3). The processing room is preferably of a size of at least 25 m² with a ceiling height of at least 4 m. There should be sufficient space and equipment in the processing room for washing and sanitation of the composting containers. The processing room 202 can immediately adjoin the re-burial room 201.

For the embodiment of the device 1 as shown in FIGS. 28, 29 and 38, it is conceivable that the funeral ceremony may no longer take place in the re-burial room 201, but rather in a separate farewell or funeral room appropriate to the situation (for example in the style of a cemetery chapel). Then, only staff have access to the re-burial room 201.

Furthermore, a post-decomposition room can be provided, in which the post-decomposition process takes place, if this does not take place directly in the ground of a gravesite. Alternatively, the post-decomposition process can take place in the processing room 202. The post-decomposition containers N prepared in the processing room 202 are stored in the post-decomposition room. Ventilation, moisture and temperature in the post-decomposition room should be suitable and optionally regulatable for the requirements of the post-decomposition process.

1. A method for composting organic material, comprising at least the following steps:
providing a composting container for the organic material to be composted, introducing the organic material to be composted and a predetermined amount of a composting substrate comprising plant remains into the composting container, storing the composting container comprising the organic material to be composted and the composting substrate for a predetermined composting time, and post-processing the content of the composting container, resulting from the organic material and the composting substrate, after the predetermined composting time for producing a plantable humus mixture,
wherein at least one of;
during the storage at least one rotation of the composting container about an axis of rotation takes place, which is non-parallel to an effective direction of a weight force acting on the composting container, and
at least one of before and during the storage of the composting container in each case at least one of predetermined amounts of liquid and oxygen are filled into the composting container.

2. The method according to claim 1, wherein the liquid contains water.

3. The method according to either claim 1, wherein at least one of
at least the amount of at least one of liquid and oxygen to be filled into the composting container during the storage is filled into the composting container at at least one timepoint that can be predetermined by means of an electronic controller,
at least one of the amount of at least one of liquid and oxygen to be filled in and the amount of composting substrate to be introduced are predetermined automatically by control electronics depending on at least one of a detected weight and a detected size of the organic material, and
the amount of one or more components of the composting substrate to be used are predetermined depending on at least one of a detected weight and a detected size of the organic material.

4. (canceled)

5. (canceled)

6. (canceled)

7. (canceled)

8. (canceled)

9. (canceled)

10. The method according to claim 1, wherein during the storage at at least two different timepoints at least one rotation of the composting container takes place in each case.

11. The method according to claim 1, wherein at least one of the at least one rotation of the composting container takes place in a manner actuated by external power, and the timepoint of the at least one rotation is predetermined by means of control electronics.

12. (canceled)

13. A method for composting organic material, comprising at least the following steps:
providing a composting container for the organic material to be composted, introducing the organic material to be composted and a predetermined amount of a composting substrate comprising plant remains into the composting container, storing the composting container comprising the organic material to be composted and the composting substrate for a predetermined composting time, and post-processing the content of the container, resulting from the organic material and the composting substrate, after the predetermined composting time for producing a plantable humus mixture,
wherein the content of the composting container is held during storage over at least one heating element or a conditioning unit in a predetermined temperature range.

14. The method according to claim 13, wherein the content of the composting container is held, during storage, in a predetermined temperature range in a electronically controlled manner via the at least one heating element or the conditioning unit, and specifically depending on at least one measured value detected by sensor, which is representative for a state in the composting container.

15. The method according to claim 1, wherein the composting time is predetermined depending on at least one measured value acquired by sensors, which is representative for a state in the composting container.

16. The method according to claim 1, wherein the post-processing of the content of the composting container includes at least one of sieving of the content and grinding of bone pieces from the originally introduced organic material that are still present in the content of the composting container.

17. The method according to claim 1, wherein the composting container is mounted, for storage, on a carrier frame of a device for composting.

18. (canceled)

19. A device for composting organic material, comprising:
a composting container for the organic material to be composted and for a predetermined amount of a composting substrate comprising plant remains, and
a timer for specifying a composting time for which the composting container comprising the organic material to be composted and the composting substrate is to be stored, before a first composting mixture, which has resulted after the composting time, from the organic material and the composting substrate, inside the composting container, is post-processed for producing a plantable humus mixture,
wherein at least one of;
the device comprises a carrier frame for the composting container, on which frame the composting container is mounted so as to be rotatable about an axis of rotation which is non-parallel to an effective direction of a weight force acting on the composting container,
at least one inflow opening is provided on the composting container, via which at least one of before and/or during the storage of the composting container a predetermined amount of at least one of liquid and oxygen can be filled into the composting container, and
the device comprises at least one heating element, via which the content of the composting container can be held in a predetermined temperature range during storage.

20. The device according to claim 19, wherein the device comprises control electronics which are configured at least one of to specify at least one timepoint during the storage at which a certain amount of at least one of liquid and oxygen is to be filled into the composting container, and to control the filling of at least one of the liquid and the oxygen into the composting container during the storage via at least one inflow element, actuatable by external power, of an inflow system of the device that is coupled to the control electronics.

21. (canceled)

22. The device according to claim 19, wherein the device comprises at least one drive motor for rotating the composting container on the carrier frame in a manner actuated by external power.

23. The device according to claim 19, wherein the device comprises at least one sensor via which at least one measured value can be detected which is representative for a state in the composting container.

24. The device according to claim 23, wherein control electronics of the device are configured to control, on the basis of the at least one detected measured value, at least one of;
filling of at least one of the liquid and the oxygen into the composting container, and
a rotation of the composting container on the carrier frame, and
the temperature range for the at least one heating element and the heating element, and
the composting time predetermined by the timer.

25. (canceled)

26. The device according to claim 19, wherein the device comprises at least one of;
a housing for the carrier frame which defines a receiving space in which the composting container, rotatably mounted on the carrier frame, is surrounded peripherally, and
a bearing unit having a plurality of bearing points, wherein each bearing point comprises a carrier frame for the rotatable mounting of a composting container.

27. (canceled)

28. (canceled)

29. (canceled)

30. The device according to claim 19, wherein the composting container comprises at least one of;
a cavity in a wall or in a floor element provided on an underside of the composting container, in which at least one electronic component and/or the at least one heating element are received, and
at least one port for an electrical connection to a superordinate electronic controller of the device.

31. (canceled)

32. A device for composting organic material, comprising:
a composting container for the organic material to be composted and for a predetermined amount of a composting substrate comprising plant remains, and
a timer for specifying a composting time for which the composting container comprising the organic material to be composted and the composting substrate is to be stored, before a first composting mixture, which has resulted after the composting time, from the organic material and the composting substrate, inside the composting container, is post-processed for producing a plantable humus mixture,
wherein at least one of;
at least one inflow opening is provided on the composting container, via which at least one of before and during the storage of the composting container a predetermined amount of at least one of liquid and oxygen can be filled into the composting container,
the device comprises a carrier frame for the composting container, on which frame the composting container can be mounted, and
the device comprises at least one heating element, via which the content of the composting container can be held in a predetermined temperature range during storage.

33. The device according to claim 32, wherein the composting container is mounted on the carrier frame so as to be rotatable about an axis of rotation which is non-parallel to an effective direction of a weight force acting on the composting container, wherein the carrier frame comprises bearing rollers for mounting the composting container.

34. (canceled)

35. The device according to claim 32, wherein the device comprises at least one of;
a drive device for rotating the composting container in a manner actuated by external power, wherein the composting container is in particular mounted on the carrier frame, during the rotation, and
control electronics which are configured at least one of to specify at least one timepoint during the storage at which a certain amount of at least one of liquid and oxygen is to be filled into the composting container, and to control the filling of at least one of the liquid and the oxygen into the composting container during the storage via at least one inflow element, actuatable by external power, of an inflow system of the device that is coupled to the control electronics.

36. (canceled)

37. (canceled)

38. The device according to claim 32, wherein the device comprises at least one sensor via which at least one measured value can be detected which is representative for a state in the composting container.

39. The device according to claim 38, wherein control electronics of the device are configured to control, on the basis of the at least one detected measured value, at least one of;
filling of at least one of the liquid and the oxygen into the composting container, and
a rotation of the composting container, in particular on the carrier frame, and the temperature range for the at least one heating element and the heating element, and
the composting time predetermined by the timer.

40. (canceled)

41. The device according to claim 32, wherein the device comprises at least one of;
a housing for the carrier frame which defines a receiving space in which the composting container, mounted on the carrier frame, is surrounded peripherally, and
a bearing unit having a plurality of bearing points, wherein each bearing point comprises a carrier frame for the mounting of a composting container.

42. (canceled)

43. (canceled)

44. (canceled)

45. The device according to claim 32, wherein the composting container comprises at least one of
a cavity in a wall or in a floor element provided on an underside of the composting container, in which at least one of at least one electronic component and the at least one heating element is/are received, and
at least one port for an electrical connection to a superordinate electronic controller of the device.

46. (canceled)

47. The device according to claim 19, wherein the device comprises at least one of;
a decorative cladding for encasing a process container of the composting container, wherein the decorative cladding can be detachably connected to the process container, and
a conditioning unit which is configured to conduct a temperature-controlled gas or gas mixture into the composting container-, in order to hold the content of the composting container in a predetermined temperature range during the storage.

48. (canceled)

49. (canceled)
